(19) United States
(12) Patent Application Publication
(10) Pub. No.: US 2025/0161906 A1
(43) Pub. Date: May 22, 2025

(54) METHOD FOR REMOVING GASES

(71) Applicant: Evonik Operations GmbH, Essen (DE)

(72) Inventors: Emmanouil SPYROU, Schermbeck (DE); Elke GOLLAN, Herne (DE); Andrea THESING, Ahaus (DE); Judith SCHODER, Haltern am See (DE); Ralf KLAWIKOWSKI, Recklinghausen (DE); Christine APPEL, Recklinghausen (DE); Florian BOECK, Witten (DE); Stephan KOHLSTRUK, Gladbeck (DE)

(73) Assignee: Evonik Operations GmbH, Essen (DE)

(21) Appl. No.: 18/952,484

(22) Filed: Nov. 19, 2024

(30) Foreign Application Priority Data
Nov. 20, 2023 (EP) 23210903

(51) Int. Cl. B01J 20/22; B01D 53/14; B01D 53/40

(52) U.S. Cl. CPC B01J 20/22; B01D 53/1456; B01D 53/40; B01D 2258/0283

(57) ABSTRACT

The present invention provides a method for removing at least one gas from a fluid stream, in which an absorbent is contacted with the fluid stream, in which the absorbent comprises at least one amino-containing compound that is an aminoalkylated isophoronediamine.

The present invention relates to a method for removing at least one gas from a fluid stream.

The removal of gases from fluid streams has become very important in recent decades. In particular, the removal of carbon dioxide (CO₂) from flue gas and offgases is desirable for various reasons. In this context, the reduction of carbon dioxide emissions is of the utmost importance, since these are considered to be the principal cause of the greenhouse effect.

Prior art technology includes the removal of CO₂ from fluid streams with amines. CO₂-containing gas/offgas streams can for example be contacted with solutions of amines. In its reaction with CO₂, the amine used forms different products: carbamates with primary or secondary amines and carbonates with tertiary amines. These products precipitate or go into solution, thereby removing the CO₂ from the gases. In order to release the bound CO₂ again, the precipitated or dissolved carbamates or carbonates are heated at a suitable point in the process. The resulting CO₂ is either stored or undergoes direct chemical reaction.

WO 2010/149599 A1 discloses a method for removing gases from a fluid stream that uses an absorption fluid comprising an amine, a stripping aid and water. The gases to be removed are preferably CO₂, H₂S, COS, mercaptans, SO₃, SO₂, CS₂ and HCN. Very particularly preferably, the amine is monoethanolamine, piperazine, methylaminopropylamine, diethanolamine or 1-hydroxyethylpiperazine.

WO 2016/068698 A1 and WO 2016/068699 A1 disclose CO₂ absorption methods in which primary, secondary or tertiary amines can be used in aqueous solution. Preference is given to using monoamines as the amine. The amines may in addition be substituted with a functional group, preferably a hydroxy group. The amines may also be cyclic amines. Very particularly preferably, the amine is N,N-dimethylcyclohexylamine (DMCA), N-methylcyclohexylamine (MCA) or a mixture thereof.

WO 2014/140108 A1 discloses a method for absorbing CO₂ from a CO₂-containing gas stream that uses a CO₂ absorbent comprising a thermoresponsive copolymer comprising amine monomers. The amine monomers may be any polymerizable monomer having at least one primary, secondary or tertiary amino functional group. Preferred amine monomers may be selected from the group consisting of amine-functionalized acrylamides, amine-functionalized methacrylamides, amine-functionalized acrylates, amine-functionalized methacrylates and cyclic amine monomers. However, a disadvantage of the described method is that the copolymer needs to be laboriously synthesized. The disclosed CO₂ absorbent may in addition include an amine component dissolved in water. The compounds mentioned in this regard include inter alia 3,3,5-trimethylcyclohexylamine, N-methylcyclohexylamine, N,N-dimethylcyclohexylamine, N-methyldiethanolamine, piperazine and 2-aminoethanol.

WO 2015/053619 A1 discloses a method for absorbing CO₂ from a CO₂-containing gas stream that uses a CO₂ absorbent comprising an amine-containing component, an inorganic salt and water. The amine-containing component has a boiling point of at least 100° C. The amine-containing component may be an organic compound having 2-20 carbon atoms. The compounds mentioned include inter alia 3,3,5-trimethylcyclohexylamine, N-methylcyclohexylamine, N,N-dimethylcyclohexylamine, N-methyldiethanolamine, piperazine and 2-aminoethanol.

U.S. Pat. No. 4,112,050 A discloses inter alia the suitability for the absorption of CO₂ of various cycloaliphatic amines, for example N¹-cyclohexylpropane-1,2-diamine, 1-amino-1-(2-aminoisopropyl) cyclohexane, 1-methylamino-1-aminomethylcyclopentane, 1-amino-1-aminomethylcycloheptane, N-isopropyl-1,2-diaminocyclohexane, N²-cyclohexylbutane-1,2-diamine, N²-cyclohexylpropane-1,2-diamine, N-cycloheptylethylene-1,2-diamine, N¹-cyclohexyl-2-methylpropane-1,2-diamine, 1-(2-aminoisopropyl)-2-amino-3-methylcyclopentane, N-isopropyl-1,4-diaminocyclohexane, N¹-cyclohexyl-N²-methylethylenediamine, N-cyclohexylethylenediamine, N¹-cyclohexyl-N²-ethylethylenediamine, N¹-cyclohexyl-N²-methylpropane-1,2-diamine, N-cyclohexylpropane-1,3-diamine, p-menthane-1,8-diamine, 1-amino-1-aminomethylcyclohexane, 1,3-diamino-1-methylcyclohexane and N²-cyclohexyl-2-methylpropane-1,2-diamine. The described method uses aqueous solutions of the amines mentioned.

WO 2013/075697 A1 discloses a method for removing CO₂ from a fluid mixture and/or stream in which a cyclic amine is used. The disclosed cyclic amines include 1,2-diaminocyclohexane, 1,3-diaminocyclohexane, 1,4-diaminocyclohexane, 1,2,3-triaminocyclohexane, 1,2,4-triaminocyclohexane, 1,3,5-triaminocyclohexane, 1,8-diazabicyclo[5.4.0]undec-7-ene, 1,5-diazabicyclo[4.3.0]non-5-ene, N-methylcyclohexanediamine, N¹, N²-1,2-dimethylcyclohexanediamine, N¹, N¹, N²-trimethylcyclohexane-1,2-diamine, N-methyl-1,3-cyclohexanediamine, N¹, N¹-dimethyl-1,3-cyclohexanediamine, N¹, N³-dimethyl-1,3-cyclohexanediamine, N-methylcyclohexane-1,4-diamine, N¹, N¹-dimethylcyclohexane-1,4-diamine, N¹, N⁴-dimethylcyclohexane-1,4-diamine, N¹, N⁴, N⁴-trimethylcyclohexane-1,4-diamine, indole and isophoronediamine. Very particular preference is given to isophoronediamine. Preferred amines, more particularly isophoronediamine, form carbamates with CO₂ that are at least partially insoluble in the solvent used and can be removed as a solid or liquid phase. This permits an easier and less energy-intensive recovery of the bound CO₂.

WO 2022/085789 A1 also discloses a method for storing CO₂ that uses amines in which the hydrocarbon framework is cyclic in form. Examples of compounds mentioned and used in the experiments include isophoronediamine, cyclohexylamine, cyclohexane-1,2-diamine, cyclohexane-1,4-diamine and 4,4′-methylenebis (2-methylcyclohexylamine).

ACS Environ. Au 2022, 2, 354-362 discloses a study in which the absorption capacities of different amines are compared. Primary amines show higher storage efficiency than secondary and tertiary amines, possibly on account of steric hindrance. However, primary aromatic amines such as aniline absorb virtually no CO₂.

Diamines with an aminocyclohexyl group have a higher storage capacity than monoamines and, unlike the latter, have the advantage of resulting in insoluble precipitates. In addition, a particularly high CO₂ storage capacity in conjunction with a particularly advantageous long efficiency period (T₉₀) is surprisingly disclosed for isophoronediamine. In combination with the lower desorption temperature that is also observed, isophoronediamine is found to be particularly preferable compared with monoethanolamine.

However, it would be desirable to provide methods in which the amines employed are equally suitable for storing CO₂, but the energy required for the removal of CO₂ from the carbamates of the amines employed can be reduced further.

Surprisingly, it has now been found that aminoalkylated isophoronediamine achieves the object of absorbing CO₂ particularly well and desorbing it again at particularly low temperatures.

The present invention thus provides a method for removing at least one gas from a fluid stream, in which an absorbent is contacted with the fluid stream, the absorbent comprising at least one amino-containing compound that is an aminoalkylated isophoronediamine.

The fluid stream from which at least one gas is to be removed may be the stream of a fluid selected from gases and liquids. If the fluid is a gas, the fluid is preferably selected from the group of gases consisting of natural gas, syngas, coke oven gas, cleavage gas, coal gasification gas, recycle gas, landfill gas and combustion gas. If the fluid is a liquid, the liquid is preferably selected from liquefied petroleum gas (LPG, autogas) and liquid natural gas (LNG) or one of the preferred gases mentioned above in liquefied form.

The method according to the invention is particularly suitable for removing gases from likewise gaseous fluid streams.

Under the method conditions and further preferably under SATP conditions (298.15 K, 1.013 bar) too, the gas to be removed is present in the form of gaseous compounds. Preferably, the gas is a gas selected from CO₂, H₂S, COS, the group of gaseous thiols, SO₃, SO₂, CS₂ and HCN. Advantageously, the method according to the invention is particularly well suited for the removal of CO₂.

In the method according to the invention, the fluid stream is contacted with an 5 absorbent comprising at least one amino-containing compound. This means that the fluid stream may be contacted with an absorbent comprising one, two, three or more than three amino-containing compounds. Particularly preferably, the fluid stream is contacted with an absorbent comprising only one amino-containing compound. In order to achieve advantageous properties, it may alternatively be advantageous to contact the fluid stream with an absorbent comprising two amino-containing compounds.

An absorbent is to be understood as meaning a liquid or gaseous composition capable of absorbing the gas present in the fluid stream. Further preferably, the absorbent is liquid under the method conditions and more preferably under SATP conditions too.

At least one of the amino-containing compounds in the absorbent is an alkylated isophoronediamine. If the absorbent comprises only one amino-containing compound, the amino-containing compound is thus an aminoalkylated isophoronediamine. If the absorbent comprises more than one amino-containing compound, the amino-containing compounds may all be aminoalkylated isophoronediamines that are differently alkylated. Alternatively, the absorbent may also comprise a plurality of differently aminoalkylated isophoronediamines and other amino-containing compounds.

Aminoalkylated isophoronediamines that are alkylated exclusively at the amino group attached to the ring in the 1-position are preferred. These are able to absorb and re-release CO₂ particularly well. Corresponding aminoalkylated isophoronediamines have the formula (I) shown below,

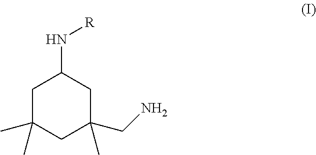

in which R is
an alkyl radical of the formula —CₙH₂ₙR′, where n=1-10 and R′=H, OH or C₁-C₃ alkyl or
an aromatic radical R=—C₆H₄R″ where R″=H, OH, or C₁-C₃ alkyl. The synthesis can be carried out in analogous manner to the disclosure of DE 10 2011 113 395 A1 from the reaction of isophorone nitrile with a corresponding primary amine and subsequent hydrogenation.

Very particularly preferably, it is methylated or ethylated isophoronediamine, i.e. compounds of the formula (I) in which R=—CH₃ or —C₂H₅.

When at least one aminoalkylated isophoronediamine is used together with at least one other amino-containing compound, any amino-containing compound may in principle be used as the latter. Preference is given to primary, secondary, tertiary, optionally hydroxy-substituted and optionally aminoalkylated amines. Very particularly preferred other amino-containing compounds may be selected from the group consisting of isophoronediamine, 4,4′-diaminodicyclohexylmethane (PACM), aminoalkylated 4,4′-diaminodicyclohexylmethanes (aminoalkylated PACMs), N,N-dimethylcyclohexylamine, N-methyldiethanolamine, piperazine and 2-aminoethanol.

Preferably, the proportion by weight of aminoalkylated isophoronediamine based on the total mass of amino-containing compounds present in the absorbent is 50-100% by weight, further preferably 70-100% by weight, even further preferably 90-100% by weight, since this allows the gas to be absorbed particularly well and desorbed again at particularly low temperatures. As already mentioned, very particular preference is given to a method in which only aminoalkylated isophoronediamine is used. The mass fraction of aminoalkylated isophoronediamine based on the total mass of amino-containing compounds present in the absorbent is in that case accordingly 100% by weight.

In principle, a solvent may be present in the absorbent. Solvents used with preference are water and organic solvents having a boiling temperature at 1.013 bar lower than that of water (appropriate alcohols and ethers in particular). Very particularly preferably, a solvent selected from the group consisting of water, methanol, ethanol, n-propanol, isopropanol, tetrahydrofuran, diethyl ether, diisopropyl ether, methyl t-butyl ether and toluene is used.

Preferably, the mass fraction of solvent in the absorbent, based on the mass of the other components present, is 0-50% by weight, preferably 0-30% by weight, very particularly preferably 0-10% by weight.

However, the method is even further preferably executed without solvent. Thus, very particularly preferably, the mass fraction of solvent in the absorbent, based on the mass of the other components present, is no added solvent, i.e. 0% by weight. Surprisingly, it was found that the products formed from aminoalkylated isophoronediamine and the gas to be removed, more particularly the carbamates formed from aminoalkylated isophoronediamine and CO₂, precipitate not only from the typical solvents, but also from the liquid aminoalkylated isophoronediamine present and serving as solvent. Thus, the solvent-free method variant surprisingly permits the method to be executed as a particularly preferred two-stage method with reduced energy consumption, since the solvent does not need to be laboriously removed, purified or heated with the product obtained. Furthermore, the use of solvents is generally disadvantageous, given the desired reduction in the VOC content. A particularly preferred method is thus a method for removing at least one gas, preferably CO₂, from a fluid stream in which an absorbent is contacted with a fluid stream, wherein
the absorbent comprises at least one amino-containing compound that is an aminoalkylated isophoronediamine, and
the absorbent is solvent-free, and
the absorbent is contacted with the fluid stream,
the product formed
   from an amino-containing compound (more particularly aminoalkylated isophoronediamine) and
   the gas to be removed (more particularly CO₂),
   more particularly carbamate formed from aminoalkylated isophoronediamine and CO₂,
precipitates from the absorbent
and is removed from the absorbent and optionally dried, and
the removed and optionally dried product is treated such that the absorbed gas is released again.

Preferably, the absorbent is contacted with the fluid stream in such a way that the fluid stream is passed through the absorbent. For better distribution, the fluid stream may be passed through a percolator or through another appropriate measure that makes the interface between the liquid absorbent and the gas larger. Further preferably, this is done by spraying the absorbent in the fluid stream.

Preferred reaction times are between 5 minutes and 48 h, preferably 10 minutes and 12 h. Preferred reaction temperatures are between ambient temperature (i.e. no heating) and 80° C. The reaction temperatures are preferably between room temperature and 50° C.

The precipitation of the product from aminoalkylated isophoronediamine and the gas to be removed can be aided by adding substances that promote precipitation. Particularly suitable solvents that promote precipitation can be selected from the group of alcohols and ethers.

Preference is given to removing the product that has formed by filtration or centrifugation.

The release of the absorbed gas may be effected by standard means known to those skilled in the art. The released gas may either be stored in a manner known to those skilled the art or may undergo direct chemical reaction. If the absorbent is recovered in the same form when the gas is released, it is preferably returned to the method of the invention.

More particularly, where the gas to be removed is CO₂, the release of the CO₂ can be effected by heating the carbamates formed. The amino-containing compounds initially employed that are then likewise released, more particularly the recovered aminoalkylated isophoronediamine, may be returned to the absorbent for the method. In principle, a basic or acidic catalyst may be supplied for the elimination of CO₂. Preference is however given to executing the method without a catalyst. It is in addition possible to adjust the pH by electrolytic methods in order to lower the elimination temperature still further. In addition, it may be helpful to introduce an inert gas, more particularly nitrogen, for the elimination of CO₂.

### EXPERIMENTAL SECTION

a) Comparative Example

Air is blown through isophoronediamine for 24 hours until crystals have formed. According to NMR spectroscopy, these crystals consist of the carbamate of IPD and CO₂. The crystals are stable in air. DSC shows a decomposition (elimination of CO₂) at 144-149° C. (848 J/g). When these crystals are heated in air (30 min, 150° C.), pure IPD is recovered (NMR).
b) Comparative Example

CO₂ is blown through N-methylcyclohexylamine for 24 hours until crystals have formed. The crystals obtained are unstable and rapidly liquefy in air. DSC shows a decomposition (elimination of CO₂) at 54-87° C. (650 J/g) and at 148-149°° C. (220 J/g). The first peak explains the lack of stability at room temperature, while the second one documents an increased input of energy compared with inventive example c).
c) Inventive Example

Air is blown through N-methyl-IPD for 24 hours until crystals have formed. According to NMR spectroscopy, these crystals consist of the carbamate of N-methyl-IPD and CO₂. The crystals are stable in air. DSC shows a decomposition (elimination of CO₂) at 123-126° C. (742 J/g). When these crystals are heated in air (30 min, 130° C.), pure N-methyl-IPD is recovered (NMR).

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 23210903, filed Nov. 20, 2023, are incorporated by reference herein.

1. Method for removing at least one gas from a fluid stream, in which an absorbent is contacted with the fluid stream,
wherein the absorbent comprises at least one amino-containing compound that is an aminoalkylated isophoronediamine.

2. Method according to claim 1,
wherein the fluid stream is a stream of a fluid selected from the group of gases consisting of natural gas, syngas, coke oven gas, cleavage gas, coal gasification gas, recycle gas, landfill gas, combustion gas, liquefied petroleum gas and liquid natural gas.

3. Method according to claim 1,
wherein the gas is selected from CO₂, H₂S, COS, the group of gaseous thiols, SO₃, SO₂, CS₂ and HCN.

4. Method according to claim 1,
wherein the absorbent comprises an amino-containing compound.

5. Method according to claim 1,
wherein the absorbent comprises two amino-containing compounds.

6. Method according to claim 1,
wherein the aminoalkylated isophoronediamine is the formula (I) 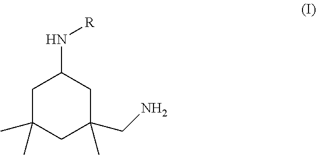
where R=—CₙH₂ₙR′
where n=1-10 and
R′=H, OH or C₁-C₃ alkyl
or R is an aromatic radical of the formula —C₆H₄R″
where R″=H, OH or C₁-C₃ alkyl.

7. Method according to claim 6,
wherein R=—CH₃ or —C₂H₅.

8. Method according to claim 1,
wherein the at least one aminoalkylated isophoronediamine is used together with at least one other amino-containing compound selected from isophoronediamine, 4,4′-diaminodicyclohexylmethane (PACM), aminoalkylated 4,4′-diaminodicyclohexylmethanes (aminoalkylated PACMs), N,N-dimethylcyclohexylamine, N-methyldiethanolamine, piperazine and 2-aminoethanol.

9. Method according to claim 1,
wherein the mass fraction of aminoalkylated isophoronediamine based on the total mass of amino-containing compounds present in the absorbent is 50-100% by weight.

10. Method according to claim 1,
wherein the method is executed without solvent.

11. Method according to claim 1,
the absorbent is solvent-free, and
the absorbent is contacted with the fluid stream,
the product formed
from an amino-containing compound and
gas to be removed,
precipitates from the absorbent
and is removed from the absorbent and optionally dried, and
the removed and optionally dried product is treated such that the absorbed gas is released again.
